(19) United States
(12) Patent Application Publication
(10) Pub. No.: US 2016/0207462 A1
(43) Pub. Date: Jul. 21, 2016

(54) Universal Mirror Mount System

(71) Applicant: Rydeen North America, Inc., Torrance, CA (US)

(72) Inventor: Philip Maeda, Torrance, CA (US)

(73) Assignee: Rydeen North America, Inc., Torrance, CA (US)

(21) Appl. No.: 14/601,482

(22) Filed: Jan. 21, 2015

(51) Int. Cl. B60R 1/04

(52) U.S. Cl. CPC B60R 1/04

(57) ABSTRACT

A vehicle rearview mirror assembly having a recess formed in the rear thereof and a mirror mount having one end that fits into the recess. The end attached to the recess is then secured to the assembly and a second end is attached to the vehicle windshield.

### BACKGROUND OF THE INVENTION

1. Field of the Invention

The present invention provides a universal detachable mirror mount system for vehicle rear view mirrors.

2. Description of the Prior Art

Current systems for mounting rear view mirrors to the interior of a vehicle are limited to the extent that it is useful for specific type of vehicles. For example, typical rear view mirror assemblies provide a mount structure which can be used only with selected vehicles. For installers of various vehicle equipment, this causes significant problems since they typically would have to keep significant numbers of rearview assemblies available such that when a customer requests an exchange of rearview mirror assembly for a specific vehicle, the installer has that assembly available. This fact increases the operating costs of these type of businesses which are typically small in size.

What is desired is to provide a specific rearview mirror that is modified to receive a variety of mounts, the mounts engaging on one end of the rearview mirror assembly, the other mount end designed to engage the vehicle windshield.

### SUMMARY OF THE INVENTION

The present invention provides a vehicle rearview mirror assembly that has been designed to engage a multitude of rearview mirror mounts. The ability of functioning as a universal rearview mirror enables repair shops and car dealers (aftermarket service providers) to reduce their inventory of rearview mirrors and mirror mounts. In essence, the present invention is directed to supplying aftermarket providers with a simple rearview mirror having multiple functions and a specifically formed recess on the back end so that the rearview mirror mounts of most vehicles can be coupled to the rearview mirror assembly. Thus, the rearview mirror assembly is capable of being used with most vehicles.

Specifically, a rearview mirror assembly, designed to have multiple functions such as the standard mirror function along with navigation and rearview camera capabilities (such as described in U.S. Pat. No. 8,717,521 B2 assigned to the assignee of the present invention), is modified on the backend such that it is compatible with a variety of mirror mounts. Specifically, a recess is formed in the back of the rearview mirror, the recess including a plurality of threaded holes. Rearview mirror mounts, designed for use with specific vehicle models, typically have an end modified with an attachment member such that it is capable of fitting into the recess, the attachment member having holes which align with the holes formed in the recess. When the attachment member is inserted into the recess, screws are inserted through the co-aligned holes and then tightened in a manner such that mount is secured to the rearview mirror. The other end of the mount is then secured to the vehicle windshield in a conventional manner. In essence, various types of mirror mounts can be fitted to specific vehicle windshield mirror attachment structures.

### DESCRIPTION OF THE DRAWINGS

For a better understanding of the present invention as well as other objects and further features thereof, reference is made to the following description which is to be read in conjunction with the accompanying drawing therein:

FIG. 1 is a perspective view of a first embodiment of the rear portion of a rearview mirror assembly formed in accordance with the teachings of the present invention;

FIG. 2 is a perspective view showing a ball joint assembly having one end inserted into the recess formed in the rear portion of the mirror assembly;

FIG. 3 is a perspective view of a second embodiment of the rearview mirror assembly formed in accordance with the teachings of the present invention; and

FIG. 4 is a perspective view of the mirror assembly shown in FIG. 3 showing a ball joint assembly having one end inserted into a recess formed in the rear portion of the mirror assembly.

### DESCRIPTION OF THE INVENTION

The present invention provides vehicle rearview mirror assemblies each having a sized recess on the rear portion of the assembly which is adopted to receive one end of a mount that fits into the recess, the other end of the mount being secured to the vehicle windshield.

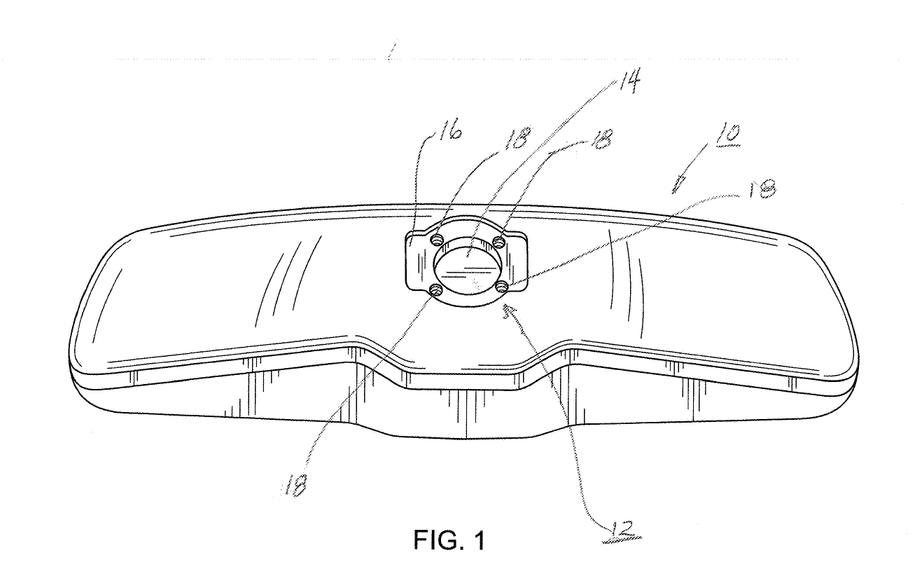

Referring now to FIG. 1, a rearview mirror assembly 10 is illustrated (the mirror 10 is of a conventional design).

Recess 12 comprises an opening 14 having a predetermined depth and a flange shaped portion 16 having a plurality of threaded holes 18 formed therein.

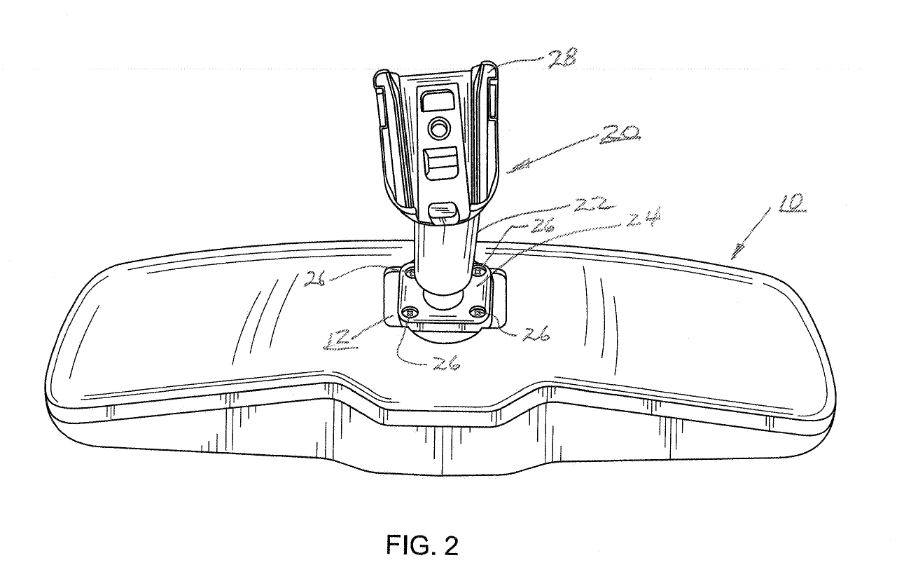

FIG. 2 illustrates a detachable mirror mount assembly 20 having a ball socket 22, bracket mount 24 and a plurality of fasteners, such as screws, 26. For the installation, bracket mount 24 is positioned in recess 12 so that fasteners 26 are aligned with holes 18, fasteners 26 then being screwed (tightened) into their aligned holes. The other end of mirror mount assembly 28 is secured to the windshield of a vehicle in a conventional manner. Forming a recess into the rear of a conventional rear view mirror enables a vehicle parts supplier to furnish the rearview mirror and mirror mounts designed for specific vehicles together in a kit, or package, to those facilities that install replacement parts in vehicles. This will substantially minimize the inventory required in those facilities.

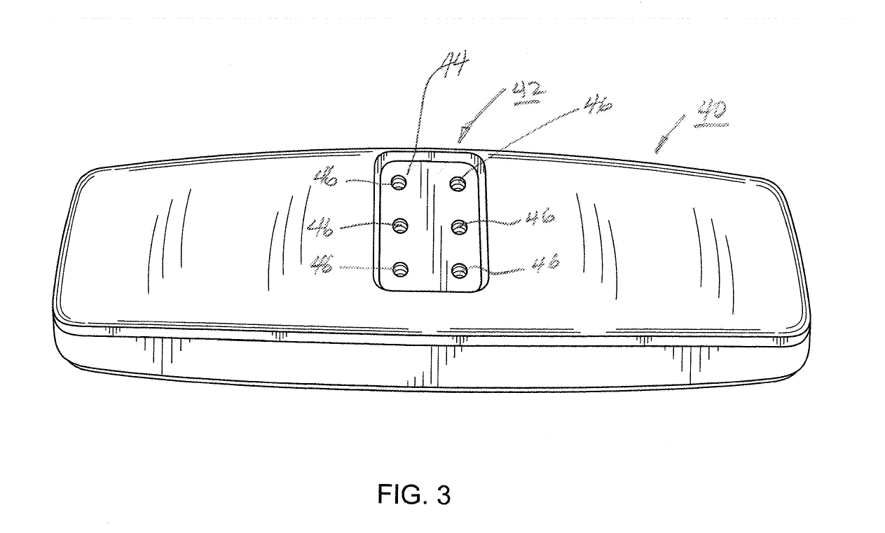

Referring to FIG. 3, a rear perspective view of rearview mirror 40 is illustrated and is a second embodiment of the present invention. In this case, mirror 40 is larger and heavier than the mirror shown in FIG. 1 and thus requires a different mounting recess. Specifically, mirror assembly 40 has recess 42 formed on its rear side. Recess 42 has an aperture 44 and a plurality of threaded holes 46. The dimensions of recess 42, including its depth, are selected so that most rearview mirror mounts can fit therein.

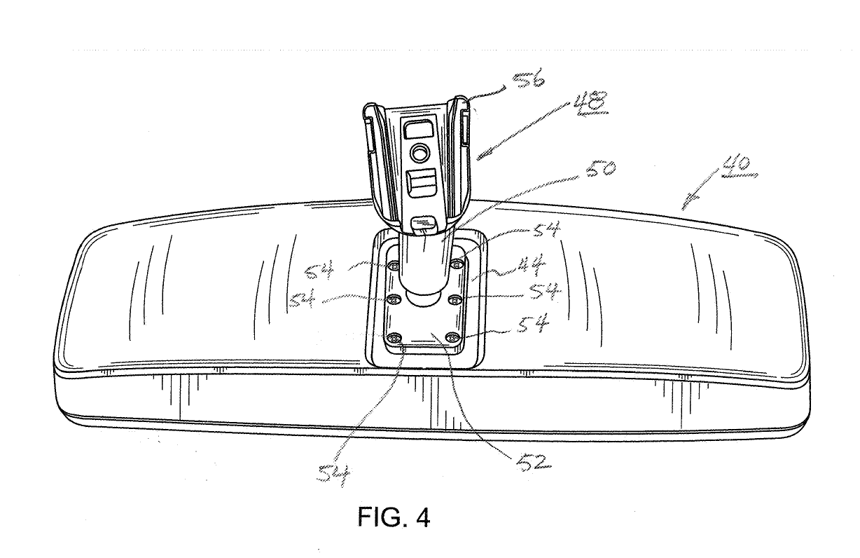

FIG. 4 illustrates detachable mirror mount assembly 48 comprising ball socket 50 having mounting bracket 52 secured to one end of socket 50, bracket 52 having a plurality of fasteners, such as threaded screws 54 positioned in apertures formed in bracket 52. An installer then aligns fasteners 54 with the holes 46 in recess 42 and the fasteners are then tightened, thus securing the rearview mirror assembly 40 to the mounting bracket 52. The other end 56 of mirror mount assembly 48 is attached to a vehicle windshield in a conventional manner.

While the invention has been described with reference to its preferred embodiments, it will be understood by those skilled in the art that various changes may be made and equivalents may be substituted for elements thereof without departing from the true spirit and scope of the invention. In addition, many modifications may be made to adapt a particular situation or material to the teachings of the invention without departing from its essential teachings.

1. A universal vehicle rearview mirror assembly comprising:
a first rearview mirror having first and second surfaces, a recess being formed in said second surface, and
a first mirror mount having first and second ends, the first end of said first mirror mount having a first connector member attached thereto, said first connector member being sized to fit into said recess; the second end of said first mirror mount being attached to the windshield of said vehicle, said recess and said first connector member having holes formed therein.

2. (canceled)

3. (canceled)

4. The mirror assembly of claim 1 further including a plurality of first fastener members, said first fastener members being inserted through aligned holes of said first connector member and said recess when said first mirror mount is positioned within said recess.

5. The mirror assembly of claim I wherein a second rearview mirror different than said first rearview mirror, is provided, said second rearview mirror having a second recess formed on one surface, and a second mirror mount having first and second ends, the first end of said second mirror mount having a second connector member attached thereto, said second connector member being sized to fit into said second recess, the second end of said second mirror mount being attached to said vehicle windshield.

6. The assembly of claim 5 wherein said second connector member has a plurality of holes formed therein.

7. The assembly of claim 6 further including a plurality of second fastener members, said second fastener members being inserted through aligned holes of said second connector member and said recess when said second mirror mount is positioned in said recess.
